(19) United States
(12) Patent Application Publication
(10) Pub. No.: US 2024/0294081 A1
(43) Pub. Date: Sep. 5, 2024

(54) SYSTEM AND METHOD FOR CHARGING ELECTRIC VEHICLES

(71) Applicant: Ford Global Technologies, LLC, Dearborn, MI (US)

(72) Inventors: Jon Zimmerman, Ferndale, MI (US); Hussein Chami, Dearborn, MI (US); Brian McIntyre, Dexter, MI (US); Francis Maslar, Grosse Ile, MI (US); Yifan Chen, Ann Arbor, MI (US); Raj Sohmshetty, Canton, MI (US); Smruti Panigrahi, Novi, MI (US)

(73) Assignee: Ford Global Technologies, LLC, Dearborn, MI (US)

(21) Appl. No.: 18/177,964

(22) Filed: Mar. 3, 2023

(51) Int. Cl. B60L 53/35; B60L 53/12; B60L 53/16

(52) U.S. Cl. CPC B60L 53/35; B60L 53/12; B60L 53/16

(57) ABSTRACT

A system for charging electric vehicles includes a robot, an electric charger, a vehicle localization structure, and a control system. The vehicle localization structure defines a charge zone located at a fixed position. The control system is configured to determine that a corresponding electric vehicle of the electric vehicles is in the charge zone, determine a position of a charge port of the corresponding electric vehicle based on the fixed position of the vehicle localization structure and vehicle parameters of the corresponding electric vehicle, and instruct the robot to move a charger of the electric charger from the electric charger to the charge port of the corresponding electric vehicle such that the charger is electrically coupled to the corresponding electric vehicle.

### FIELD

The present disclosure relates to a system and method for charging electric vehicles.

### BACKGROUND

The statements in this section merely provide background information related to the present disclosure and may not constitute prior art.

Various types of automotive vehicles such as battery electric vehicles (BEVs), hybrid electric vehicles (HEVs), plug-in electric vehicles (PHEVs), or fuel cell vehicles, for example, include one or more electric motors that employs electrical energy stored in an energy storage apparatus, such as one or more vehicle batteries, to perform one or more propulsion-based operations. The energy storage apparatus requires periodic charging by connecting the energy storage apparatus to a power source.

The teachings of the present disclosure address these and other issues with charging the energy storage apparatuses of electric vehicles.

### SUMMARY

This section provides a general summary of the disclosure and is not a comprehensive disclosure of its full scope or all of its features.

In one form, the present disclosure provides a system for charging a plurality of electric vehicles. The system includes a robot, a first electric charger, a first vehicle localization structure, and a central control system. The first vehicle localization structure defines a first charge zone located at a first fixed position. The central control system configured to determine that a corresponding electric vehicle of the electric vehicles is in the first charge zone, determine a position of a charge port of the corresponding electric vehicle based on the first fixed position of the first vehicle localization structure and vehicle parameters of the electric vehicle, and instruct the robot to move a charger of the first electric charger from the first electric charger to the charge port of the corresponding electric vehicle such that the charger is electrically coupled to the corresponding electric vehicle.

In variations of the system of the above paragraph, which can be implemented individually or in any combination: the vehicle parameters comprise vehicle dimensions, tire locations and dimensions, and charging port locations and dimensions; the first vehicle localization structure includes a pair of rails extending parallel to each other and defining the first charge zone therebetween, the pair of rails set a lateral position of the corresponding electric vehicle when the corresponding electric vehicle is located in the first charge zone; the first vehicle localization structure includes a pair of locking rollers defining the first charge zone therebetween, the pair of locking rollers set a longitudinal position of the corresponding electric vehicle when the corresponding electric vehicle is located in the first charge zone; the pair of locking rollers are movable between a stowed position in which the pair of locking rollers are disengaged from a wheel of the corresponding electric vehicle when the wheel of the corresponding electric vehicle is located in the first charge zone, and a deployed position in which the pair of locking rollers are engaged with the wheel of the corresponding electric vehicle when the wheel of the corresponding electric vehicle is located in the first charge zone; one locking roller of the pair of locking rollers is movable between a stowed position in which one locking roller is disengaged from a wheel of the corresponding electric vehicle when the wheel of the corresponding electric vehicle is located in the first charge zone, and a deployed position in which one locking roller is engaged with the wheel of the corresponding electric vehicle when the wheel of the corresponding electric vehicle is located in the first charge zone; a motor operable in a first state in which one locking roller is in the stowed position and a second state in which one locking roller is in the deployed position; a second electric charger and a second vehicle localization structure defining a second charge zone located at a second fixed position; an overhead rail structure, the robot supported by the overhead rail structure and configured to move along the overhead rail structure between the first and second electric chargers; the robot is a mobile robot, the mobile robot is configured to autonomously travel proximate the first charge zone to charge the electric vehicle; a vehicle detection system in communication with the central control system and configured to detect the corresponding electric vehicle in the first charge zone; and the robot is a mobile robot, the mobile robot is configured to autonomously travel proximate the first charge zone to charge the electric vehicle.

In another form, the present disclosure provides a system for charging a plurality of electric vehicles. The system includes a robot, a first electric charger, a first vehicle localization structure, a vehicle detection system and a central control system. The robot is supported by the rail structure and is configured to move along the rail structure. The first vehicle localization structure defines a first charge zone located at a first fixed position. The vehicle detection system is configured to detect a corresponding electric vehicle of the electric vehicles in the first charge zone. The central control system configured to obtain data from the vehicle detection system that the corresponding electric vehicle is in the first charge zone, determine a position of a charge port of the corresponding electric vehicle based on the first fixed position of the first vehicle localization structure and vehicle parameters of the corresponding electric vehicle, and instruct the robot to move a charger of the first electric charger from the first electric charger to the charge port of the corresponding electric vehicle such that the charger is electrically coupled to the corresponding electric vehicle.

In variations of the system of the above paragraph, which can be implemented individually or in any combination: the vehicle parameters comprise vehicle dimensions, tire locations and dimensions, and charge port locations and dimensions; the first vehicle localization structure includes a pair of rails extending parallel to each other and defining the first charge zone therebetween, the pair of rails set a lateral position of the corresponding electric vehicle when the corresponding electric vehicle is located in the first charge zone; the first vehicle localization structure includes a pair of locking rollers defining the first charge zone therebetween, the pair of locking rollers set a longitudinal position of the corresponding electric vehicle when the corresponding electric vehicle is located in the first charge zone; the pair of locking rollers are movable between a stowed position in which the pair of locking rollers are disengaged from a wheel of the corresponding electric vehicle when the wheel of the corresponding electric vehicle is located in the first charge zone, and a deployed position in which the pair of locking rollers are engaged with the wheel of the corresponding electric vehicle when the wheel of the corresponding electric vehicle is located in the first charge zone; the central control system moves the pair of locking rollers from the stowed position to the deployed position in response to the central control system obtaining data from the vehicle detection system that the corresponding electric vehicle is in the first charge zone; and a second electric charger and a second vehicle localization structure defining a second charge zone located at a second fixed position, the robot is configured to move along the rail structure between the first and second electric chargers.

In yet another form, the present disclosure provides a method for charging a plurality of electric vehicles. The method includes obtain data from a vehicle detection system that a corresponding electric vehicle of the electric vehicles is in a charge zone of a vehicle localization structure, determine a position of a charge port of the corresponding electric vehicle based on a fixed position of the vehicle localization structure and vehicle parameters of the corresponding electric vehicle, and control a robot to move a charger of an electric charger from the electric charger to the charge port of the corresponding electric vehicle such that the charger is electrically coupled to the corresponding electric vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a functional block diagram of an example manufacturing environment in accordance with the teachings of the present disclosure;

FIG. 1B is a perspective view of an example charging port cover of one electric vehicle in accordance with the teachings of the present disclosure;

FIG. 1C is a perspective view of a robotic charging system in accordance with the teachings of the present disclosure;

FIG. 2 is a top view of a portion of a vehicle localization structure in accordance with the teachings of the present disclosure;

FIG. 3 is a side view of a portion of the vehicle localization structure in accordance with the teaching of the present disclosure;

FIG. 4 is a functional block diagram of example systems in accordance with the teachings of the present disclosure; and

FIG. 5 is a flowchart of an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

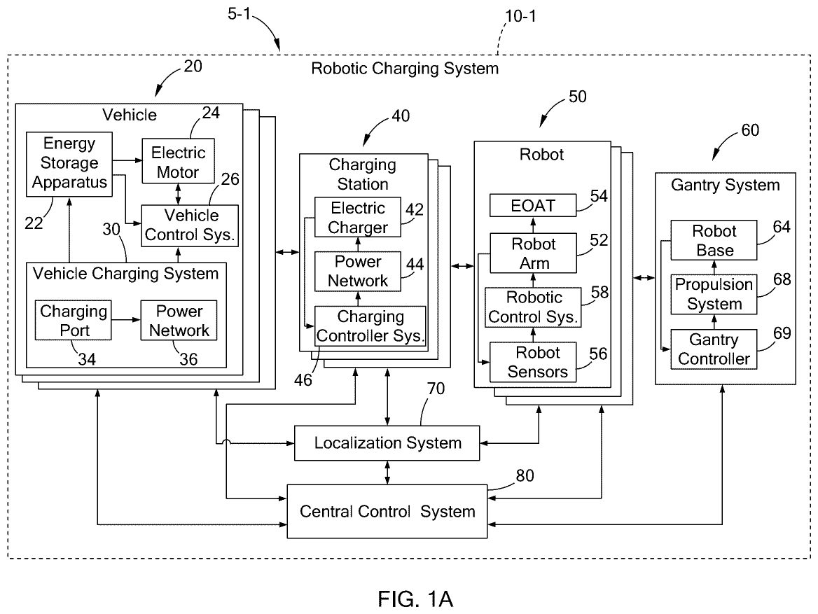

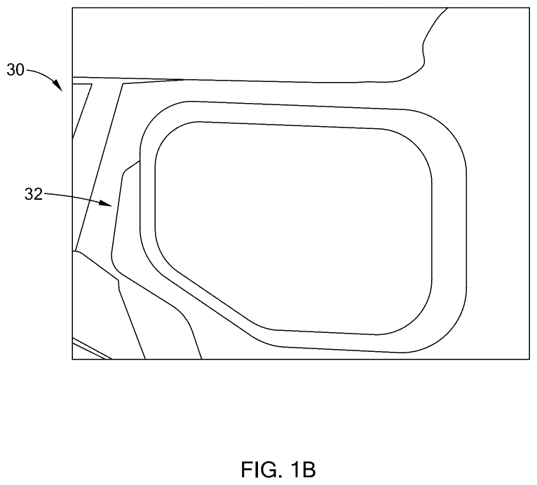

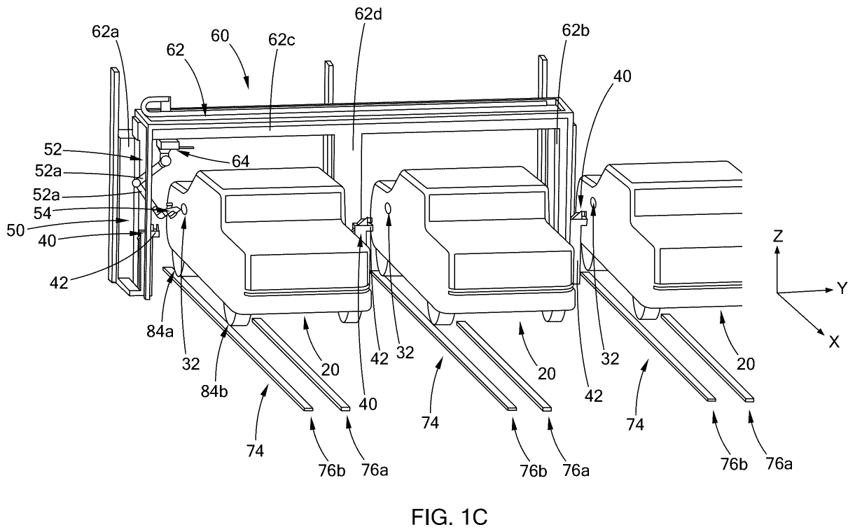

Referring to FIG. 1A, a manufacturing environment 5-1 is shown and generally includes a robotic charging system 10-1 and a plurality of vehicles 20. In one form, the robotic charging system 10-1 includes a plurality of charging stations 40, a plurality of robots 50, a gantry system 60, a localization system 70, and a central control system 80. It should be understood that any one of the modules of the vehicles 20, the charging stations 40, the robots 50, the gantry system 60, the localization system 70, and the central control system 80 can be provided at the same location or distributed at different locations (e.g., via one or more edge computing devices) and communicably coupled accordingly. In one form, the vehicles 20, the charging stations 40, the robots 50, the gantry system 60, the localization system 70, and the central control system 80 are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

In one form, the vehicles 20 are provided by electric vehicles. As used herein, “electric vehicle” refers to a vehicle that employs one or more electric motors for propulsion. Some examples of electric vehicles are battery electric vehicles (BEVs), hybrid electric vehicles (HEVs), plug-in electric vehicles (PHEVs), or fuel cell vehicles, for example. In one form, the vehicles 20 may be provided by autonomous or semi-autonomous vehicles that are configured to perform one or more known autonomous routines within the manufacturing environment 5-1, such as an autonomous navigation routine, a driver assistance routine, an adaptive cruise control routine, an autonomous braking routine, and/or an object detection routine. It should be understood that the vehicles 20 may be provided by other types of vehicles and are not limited to the examples described herein.

In one form, the vehicles 20 may each include an electric motor 24 that employ electrical energy stored in an energy storage apparatus 22, such as one or more vehicle batteries, to perform one or more propulsion-based operations. In one form, the vehicles 20 include a vehicle control system 26 that is configured to control and/or monitor a particular system or subsystem of the vehicles 20. As an example, the vehicle control system 26 may include a propulsion control module for controlling the operation of the electric motor 24, a powertrain control module for controlling operation of a powertrain system of the vehicle 20, a transmission control module for controlling operation of a transmission system of the vehicle 20, a brake control module for controlling operation of a braking system of the vehicle 20, a body control module for controlling the operation of various electronic accessories in the body of the vehicle 20, a climate control module for controlling operation of a heating and air conditioning system of the vehicle 20, and a suspension control module for controlling operation of a suspension system of the vehicle 20, among other vehicle modules. In one form, the electric motor 24, the energy storage apparatus 22, and the vehicle control system 26 are communicably coupled by a vehicle interface, such as a control system area network (CAN) bus, a local interconnect network (LIN) bus, and/or a clock extension peripheral interface (CXPI) bus.

In one form and referring to FIGS. 1A-1C, the vehicles 20 may each include a vehicle charging system 30 (FIG. 1A) that is configured to receive electrical energy from the charging stations 40. The vehicle charging system 30 may include a charging port cover 32 (FIG. 1B), a charging port 34, and a power network 36. In one form, the charging port cover 32 is movable between a closed position in which the charging port 34 and the power network 36 are inaccessible from a location external to the vehicle 20 (i.e., physically isolated from an ambient environment of the vehicle 20) and an open position in which the charging port 34 and the power network 36 are accessible from a location external to the vehicle 20. In the example illustrated, the charging cover 32 is a door or cap, for example.

In one form, the charging port 34 provides an electrical interface for physically and electrically/inductively coupling an electrical charger of the charging station 40 (described below in further detail) to the power network 36. As an example, the charging port 34 is provided by a charging receptacle (e.g., an electrical outlet) that receives one or more conductive components of the electrical charger of the charging station 40. As another example, the charging port 34 is provided by a charging pad (e.g., a wireless power transfer pad comprising one or more inductive coils) that is configured to inductively and physically couple to a charging pad of the electrical charger.

In one form, the power network 36 selectively adjusts one or more characteristics of the electric signal received from the charging stations 40 and provides the adjusted signal to the energy storage apparatus 22. As an example, the power network 36 includes an alternating current-alternating current (AC-AC) converter circuit that is configured to adjust an amplitude and/or frequency component of an AC electric signal, such as a voltage source inverter, a current source inverter, a cycloconverter, a matrix converter, among other AC-AC converter circuits. As another example, the power network 36 includes an AC-direct current (AC-DC) converter circuit that is configured to convert the AC electric signal into a DC electric signal, such as a rectifier circuit and/or other AC-DC converter circuits. As an additional example, the power network 36 includes a DC-AC converter circuit that is configured to convert the DC electric signal into an AC electric signal, such as an inverter circuit and/or other DC-AC converter circuits. As yet another example, the power network 36 includes a DC-DC converter circuit that is configured to adjust an amplitude of the DC electric signal, such as a buck converter circuit, a boost converter circuit, a buck-boost converter circuit, among other DC-DC converter circuits.

In one form, the charging stations 40 are configured to provide electrical energy to the vehicles 20 during a charging operation and include an electric charger or charging apparatus 42, a power converter network 44, and a charging station control system 46. In one form, the electric charger 42 is electrically coupled to a power grid via the power converter network 44 and may include a conductive cable (e.g., a Level 4 DC fast charger cable, a Level 3 DC charger cable, or a Level 2 AC charger cable) and a charging interface for physically and electrically/inductively coupling to the power network 36 via the charging port 34, such as a plug or a wireless charging pad. In one form, the power converter network 44 is configured to adjust one or more characteristics of the electrical power output by the grid and provide the adjusted electrical power to the energy storage apparatus 22 via the charging port 34 and the power network 36. As an example, the power network 44 may include similar circuits and converter networks as the power network 36, and as such, the description thereof is omitted for brevity.

In one form, each robot 50 includes a robot arm or robotic arm 52, an end of arm tool (EOAT) or end-effector 54, robot sensors 56, and a robot control system 58 configured to control the robotic arm 52 and the EOAT 54 to perform one or more automated tasks. Example automated tasks include, but are not limited to, retrieving the electric charger 42 from the charging station 40 and moving the electric charger 42 proximate to the vehicle 20 (e.g., the charging port 34), removing the charging port cover 32 to insert the electric charger 42 into the charging port 34, among other automated tasks.

In one form, the robotic arm 52 includes a plurality of segments 52a (FIG. 1C) connected to each other at joints, thereby allowing the robotic arm 52 to have multiple degrees of freedom. Stated differently, the robotic arm 52 is a multi-axis robotic arm having various portions that are rotatable about various axes (e.g., a six-axis robot having five degrees of freedom). In one form, the EOAT 54 is secured to an end of the robotic arm 52 and includes one or more components for performing the automated tasks described herein, such as an image/vision sensor, a hook, and a gripper. One example of such robotic arm and/or the EOAT are disclosed in U.S. Patent App. No. XX/000,000, and titled “ROBOTIC ARM ASSEMBLY FOR ELECTRIC VEHICLE CHARGER,” which is commonly owned with the present application and the contents of which are incorporated herein by reference in its entirety.

In one form, the robot sensors 56 generate data corresponding to various characteristics of the robot 50. As an example, the robot sensors 56 may include a location sensor (e.g., an NFC sensor or UWB sensor) configured to generate location information of the robot 50. As another example, the robot sensors 56 may include an accelerometer, a gyroscope, and/or a magnetometer configured to generate orientation information of the robot 50. As yet another example, the robot sensors 56 may include a velocity sensor configured to generate velocity information of the robot 50, a power sensor to generate power information (e.g., information regarding amount of current and/or voltage being applied by a power source to the robot 50), a torque sensor configured to generate torque information of various joints of the robot 50, and/or a touch sensor at a handle of the robot 50 configured to detect contact. The robot sensors 56 are configured to provide the corresponding data to the robot control system 58 for controlling the robotic arm 52 and/or EOAT 54.

In one form, with reference to FIGS. 1A and 1C, the gantry system 60 includes a structural base assembly 62 (FIG. 1C), one or more robot bases 64, a plurality of propulsion systems 68, and a gantry control system 69. The structural base assembly 62 is secured to a ground surface and is configured to physically support the robot bases 64. In one example, the structural base assembly 62 is permanently fixed to the ground surface. In another example, the structural base assembly 62 may include wheels that may be movable between a locked position to inhibit movement of the structural base assembly 62 in the manufacturing environment 5-1 and an unlocked position to permit movement of the structural base assembly 62 in the manufacturing environment 5-1. In the example illustrated, the structural base assembly 62 includes support legs 62a, 62b and a rail structure 62c. The support legs 62a, 62b are spaced apart from each other and extend in a vertical direction. Stated differently, the support leg 62a is disposed at a first end of the gantry system 60 and the support leg 62b is disposed at a second end of the gantry system 60 that is opposite the first end. In some forms, the base assembly 62 may include one or more optional support legs 62d positioned between the support legs 62a, 62b and extending in a vertical direction. The rail structure 62c extends in a horizontal direction and is secured to upper ends of the support legs 62a, 62b, 62d. In this way, the rail structure 62c is located above the charging stations 40 and the vehicles 20 located at the charging stations 40.

Each robot base 64 is connected to the rail structure 62c and connected to an end of a respective robotic arm 52, and is configured to move along the rail structure 62c between the charging stations 40. In this way, the robot 50 can initiate the charging operation at any one of the charging stations 40. In the example illustrated, the robot base 64 is connected to the rail structure 62c such that the robot base 64 and the respective robotic arm 52 are suspended therefrom above the ground surface. In some forms, the robot base 64 is mounted on top of the rail structure 62c such that the respective robotic arm 52 is suspended from the rail structure 62c. In one form, the robot base 64 is connected to the rail structure 62c by sets of wheels received in respective tracks of the rail structure 62c. In this way, the sets of wheels roll along the track to move the robot base 64 and the respective robotic arm 52 between the charging stations 40. In some forms, the robot base 64 may be connected to the rail structure 62c such that the robot base 64 is slidable along the rail structure 62c. One example of such structural base assembly and/or robot base are disclosed in U.S. Patent App. No. XX/000,000, and titled “SYSTEM AND METHOD FOR CHARGING ELECTRIC VEHICLES,” which is commonly owned with the present application and the contents of which are incorporated herein by reference in its entirety.

In one form, the propulsion system 68 is associated with a respective robot base 64 and includes various known components for moving the robot base 64 and the attached robot 50 along the rail structure 62c. As an example, the propulsion system 68 includes drive motors, cable carriers, electrically conductive wires, and other known components that are employed for moving the robot base 64 and the attached robot 50 along the rail structure 62c.

In one form, the localization system 70 is configured to localize the robots 50 relative to the vehicles 20 and/or the vehicles 20 relative to the robots 50. That is, the localization system 70 is configured to convert a robot-based position of the robot 50 to a vehicle-based position of the robot 50, a vehicle-based position of the vehicle 20 to a robot-based position of the vehicle 20, or a combination thereof. As an example, the localization system 70 may employ known imaging and fiducial marker systems that employ predefined robot/vehicle location coordinates and translation routines for localizing the robots 50 relative to the vehicles 20 and/or the vehicles 20 relative to the robots 50. As another example, the localization system 70 may employ known object detection systems having predefined robot/vehicle location coordinates and translation routines for localizing the robots 50 relative to the vehicles 20 and/or the vehicles 20 relative to the robots 50, such as a guard rail system.

With reference to FIGS. 1C, 2, and 3, the localization system 70 may include a plurality of vehicle localization structures 74 that are configured to position respective vehicles 20 desiring charging adjacent to respective electric chargers 42. Each vehicle localization structure 74 defines a charge zone 82 located in a known position. When the respective vehicle 20 is located within the charge zone 82, the robot 50 may move a charger of a respective electric charger 42 from the respective electric charger 42 to the charging port 34 of the respective vehicle 20 such that the charger is electrically coupled to the respective vehicle 20.

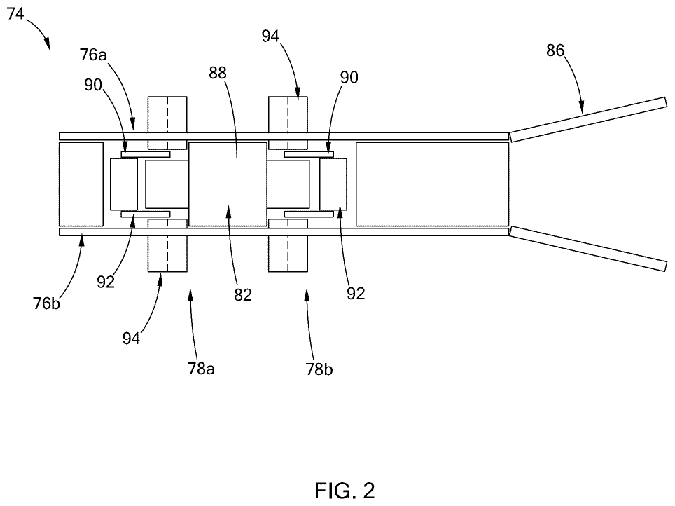

Each vehicle localization structure 74 may include a pair of elongated rails 76a, 76b and a pair of locking assemblies 78a, 78b. The pair of rails 76a, 76b may be located on a ground surface and extend parallel to each other and to the vehicle 20 being charged. The pair of rails 76a, 76b are spaced apart from each other such that the charge zone 82 is located therebetween. Stated differently, a distance between the rails 76a, 76b may be determined by a width of the wheels of the vehicle 20. The vehicle 20 desiring charging may pull into the charge station 40 adjacent the electric charger 42 such that a set of wheels 84a, 84b of the vehicle 20 is positioned between the pair of rails 76a, 76b. This sets a lateral position of the vehicle 20 (i.e., inhibits movement of the vehicle 20 in the Y direction). One wheel 84b of the set of wheels 84a, 84b is positioned at the charge zone 82, which notifies the central control system 80 to initiate the charging operation of the vehicle 20 as described in more detail below. In some forms, an alignment structure 86 (FIG. 2) is located at an end of the pair of rails 76a, 76b where the vehicle 20 enters. In this way, alignment of the vehicle 20 with respective to the pair of rails 76a, 76b is facilitated.

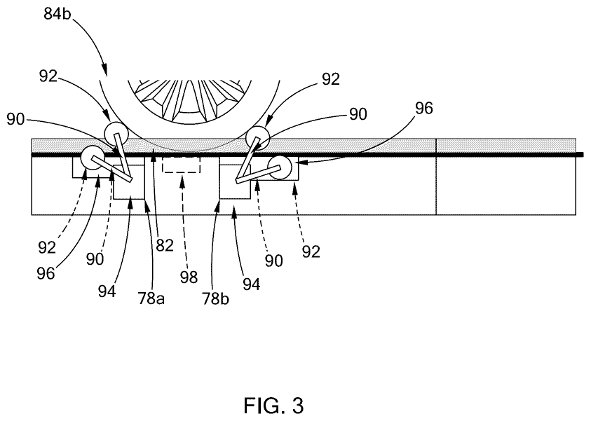

With reference to FIGS. 2 and 3, the pair of locking assemblies 78a, 78b are configured to set a longitudinal position of the vehicle 20 (i.e., the locking assemblies inhibit movement of the vehicle 20 in the X direction). The pair of locking assemblies 78a, 78b are also spaced apart from each other such that the charge zone 82 is located therebetween. In one example, the pair of locking assemblies 78a, 78b are movable between a stowed position (shown in dashed lines in FIG. 3) and a deployed position (shown in solid lines in FIG. 3). In the stowed position, the pair of locking assemblies 78a, 78b are disengaged from the wheel 84b of the vehicle 20 such that the wheel 84b may ingress into the charge zone 82 or egress out of the charge zone 82. In the deployed position, the pair of locking assemblies 78a, 78b may engage the wheel 84b in the charging zone 82 such that the wheel 84b is inhibited from egressing out of the charge zone 82 (i.e., the pair of locking assemblies 78a, 78b may engage the wheel 84a located in the charge zone 82, thereby setting a longitudinal position of the vehicle 20). In the example illustrated, a platform 88 (FIG. 2) is located in the charge zone 82 and is configured to receive the wheel 84b (i.e., the wheel 84b is configured to be positioned onto the platform 88).

With reference to FIGS. 2-4, each locking assembly 78a, 78b includes an arm 90, a locking roller 92, and a motor 94. The arm 90 is connected to the locking roller 92 and operatively coupled to the motor 94. In this way, the motor 94 may move the locking roller 92 via the arm 90. The motor 94 operates in a first state in which the locking assemblies 78a, 78b are in the stowed position and a second state in which the locking assemblies 78a, 78b are in the deployed position. In the stowed position, the locking rollers 92 of the locking assemblies 78a, 78b are located entirely below an upper surface of the platform 88 and are disengaged from the wheel 84b. In the example illustrated, the locking rollers 92 of the locking assemblies 78a, 78b are located within cavities 96 below the upper surface of the platform 88. In the deployed position, the locking rollers 92 of the locking assemblies 78a, 78b are located above the upper surface of the platform 88 and are engaged with the wheel 84b. When the motor 94 is in the second state, the locking roller 92 of the locking assembly 78a engages a forward portion of the wheel 84b and the locking roller 92 of the locking assembly 78b engages a rearward portion of the wheel 84b. In this way, the locking assemblies 78a, 78b inhibit movement of the vehicle 20 in the X direction when the wheel 84a is in the charge zone 82.

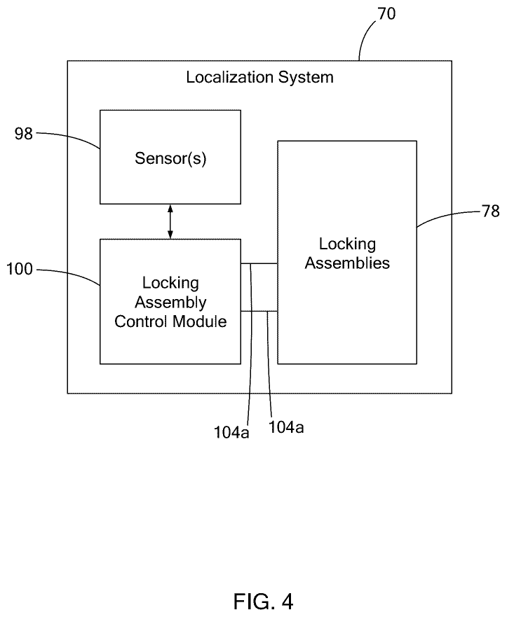

With continuing reference to FIG. 3 and now to FIG. 4, the localization system 70 further comprises one or more sensors 98, and a locking assembly control module 100. In one form, each vehicle localization structure 74 may include one or more of the sensor(s) 98 to detect the vehicle 20. More particularly, in an example application, the sensor 98 is provided at the charge zone 82 to detect the wheel 84b of the vehicle 20.

When the sensors 98 detect the wheel 84b in the charge zone 82, the sensors 98 provide a notification to the locking assembly control module 100. In some applications, the sensors 98 may also transmit a notification when the wheel 84b is no longer at the charge zone 82. In one form, the sensors 98 may be provided any suitable sensor for detecting and/or determine presence of an object such as but not limited to: a pressure sensor, imaging sensor, optical sensor. In addition, the placement of the sensors 98 should not be limited to the charge zone 82. For example, if the sensor 98 is an imaging device, the sensor 98 may be provided outside of the charge zone to capture an image of an area including the charge zone. In some variations, in lieu of the sensor 98 providing a determination of whether the wheel 84b is at the charge zone 82, the sensor 98 may transmit data to the locking assembly control module 100, which is configured to analyze the data to control the locking assemblies, as described below.

The locking assembly control module 100 is configured to control position of the locking assemblies 78a, 78b, as illustrated by lines 104a, 104b in FIG. 4. Specifically, the locking assembly control module 100 is configured to operate the motors 94 to move the arms 90 and thus, the locking rollers 92. As indicated above, in one form, the locking assembly control module 100 is configured to receive a notification from the sensor 98 and based on the notification, control the locking assemblies to lock the wheel 84b via the rollers 92. In another example, the locking assembly control module 100 may analyze data from the sensors 98 to determine if the wheel is at the charge zone. For example, if the data from the sensors 98 is data indicative of a force being applied to the platform, the locking assembly control module 100 compares the force being applied to a defined a threshold. If the force is equal to or above a threshold, the locking assembly control module 100 is configured to determine that that the wheel is at the charge zone.

Once the wheel and thus, the vehicle is locked, the locking assembly control module 100 notifies the central control system 80 to proceed with having the vehicle charged. More particularly, the vehicle localization structure 74 is configured such when the pair of locking assemblies 78a, 78b are in the deployed position, the angular positions of the locking rollers 92 are known, and thus, an approximate position of the wheel 84b along the rails 76a, 76b is also known. The location of the wheel is controlled to be at and/or within a positional range defined by the rollers 92. Knowing the approximate location of the wheel, the central control system 80 is configured to know the approximate location of the vehicle relative to the rails 76a, 76b and more particularly, an approximate location of the charging port 34 based on information related to location of various features of the vehicle 20 (e.g., location of center of the wheel, location of the charging port, distance between the center of the wheel and the charging port, among other locations measurements). With the approximate location of the charging port, the central control system 80 is configured to have the robot 50 move the conductive cable of the electric charger 42 to a location of the charging port 34 without the need of image/vision sensors. The image/vision sensors on the EOAT 54 may be employed when the conductive cable is at the location of the charging port. Once the charge operation is complete, the central control system 80 notifies the locking assembly control module 100 to have the locking assemblies 78a, 78b unlock the wheel 84b.

In some forms, the vehicle localization structure 74 may include multiple charge zones for receiving and aligning other wheels of the vehicle. For example, the vehicle localization structure 74 may include a second charge zone configured in a similar manner as the charge zone 82. While not illustrated, the second charge zone can be positioned between the rails 76a, 76b and configured to receive the wheel 84a (i.e., the wheel 84a is configured to be positioned onto a platform in the charge zone). The vehicle localization structure 74 may further include a pair of second locking assemblies (not shown) spaced apart from each other such that the second charge zone is located therebetween. The pair of second locking assemblies may be similar to the pair of locking assemblies 78a, 78b described above. When the wheel 84b of the respective vehicle 20 is located within the charge zone 82 and the wheel 84a of the respective vehicle 20 is located within the second charge zone, the robot 50 may move a charger of a respective electric charger 42 from the respective electric charger 42 to the charging port 34 of the respective vehicle 20 such that the charger is electrically coupled to the respective vehicle 20.

In some configurations, one locking assembly 78a, 78b of the pair of locking assemblies 78a, 78b may be fixed such that the roller 92 is positioned proximate to and above the platform 88, and the other locking assembly 78a, 78b of the pair of locking assemblies 78a, 78b may be movable between a stowed position and a deployed position. In this way, the vehicle 20 is moved onto the platform 88 such that the wheel 84b is in the charge zone 82 and engages the roller 92 of the fixed locking assembly 78a, 78b. Next, the movable locking assembly 78a, 78b is moved from the stowed position to the deployed position to engage the wheel 84b and inhibit movement of the vehicle 20 in the X direction. In another configuration, prior to the vehicle 20 being received, both locking assemblies 78a, 78b are provided in the deployed position above the platform 88. In this way, the vehicle 20 is moved onto the platform 88 by driving over one of the locking assemblies 78a, 78b such that the wheel 84b is positioned between the locking assemblies 78a, 78b and onto the platform 88 in the charge zone 82. Once the charge operation is complete the vehicle 20 may drive over the other locking assembly 78a, 78b. The locking assemblies 78a, 78b may be configured in various suitable ways to accommodate the movement of the vehicle. For example, the locking assemblies 78a, 78b are configured to support a load placed on the wheel 84. In another example, the locking assemblies may be resilient such that the locking assemblies may move to an area below the platform 88 when the vehicle 20 is on the respective locking assembly 78a, 78b and then return to the deployed state when the vehicle 20 is not on the respective locking assembly 78a, 78b.

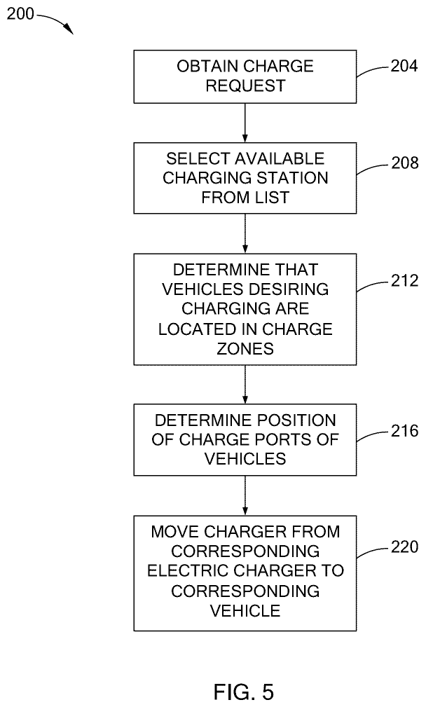

In one form, the central control system 80 is configured to control the operation of the robotic charging system 10-1. As an example, the central control system 80 obtains robot data associated with the robots 50, vehicle data associated with the vehicles 20, charging station data associated with the charging stations 40, locking assembly data associated with the locking assemblies 78a, 78b, and sensor data associated with the sensors 98a of the vehicle detection system 98. Furthermore, the central control system 80 determines whether one of the vehicles 20 has an amount of electrical energy stored in the corresponding energy storage apparatus 22 that is less than a threshold amount and instructs a selected robot 50 to perform the charging operation. Additional details regarding controlling the operation of the robotic charging system 10-1 are provided below with reference to FIG. 5.

Referring to FIG. 5, an example control algorithm 200 for charging one or more vehicles 20 is illustrated. The processing may begin once a current state of charge (SOC) level of the energy storage apparatus 22 of one or more vehicles 20 falls below a predetermined threshold SOC level. In one example, the predetermined threshold SOC level may be 60% of a fully charged state. In another example, the predetermined threshold SOC level may be 70% of a fully charged state. At 204, the control algorithm, using the central control system 80, obtains a charge request from one or more vehicles 20 requiring charging. At 208, the control algorithm, using the central control system 80, selects an available charging station 40 from a list of available charging stations 40 for each vehicle 20 desiring charging. The vehicles 20 are then driven to the selected charging stations 40. In some forms, the vehicles 20 may be autonomously driven over to the selected charging stations 40.

At 212, the control algorithm, using the central control system 80, determines that the vehicles 20 desiring charging are located in the charge zones 82. That is, when the sensors 98a detect the wheels 84b in the charge zones 82, the sensors 98a send signals to the central control system 80 notifying the central control system 80. The central control system 80 may also move the locking assemblies 78a, 78b from the stowed position to the deployed position in response to receiving signals from the sensors 98a.

At 216, the control algorithm, using the central control system 80, determines positions of the charge ports 34 of the vehicles 20 based on the known positions of the vehicle localization structures 74 and parameters of the vehicles 20. That is, when the pair of locking assemblies 78a, 78b are in the deployed position, the angular positions of the arms 90 are known. With the known angular positions of the arms 90 and the known geometric shapes of the wheel 84b, the arm 90, and the roller 92, the wheel location 84b along the rails 76a, 76b can be determined. This, in turn, allows the vehicle 20 location along the rails 76a, 76b to be determined. The vehicle 20 location along the rails 76a, 76b can then be used to determine the location of the charging port 34 in the coordinate system. The parameters of the vehicles 20 (e.g., vehicle dimensions, tire dimensions, etc.) may also be used in determining position of charge ports 34.

At 220, the control algorithm, using the central control system 80, instructs the robot 50 to move a charger of a corresponding electric charger 42 from the corresponding electric charger 42 to a corresponding vehicle 20 located within the respective vehicle charging station 40 such that the charger is electrically coupled to the charge port 34 of the corresponding vehicle 20. Stated differently, the robot 50 moves the conductive cable of the corresponding electric charger 42 to a location of the charging port 34 of the corresponding vehicle 20 without the need of image/vision sensors. In some forms, the image/vision sensors on the EOAT 54 may be employed when the conductive cable is at the location of the charging port 34 to provide for electric coupling of the conductive cable to the charging port 34. The system of the present disclosure for charging electric vehicles 20 reduces cost for vehicle charging as well as charge station utilization time.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for charging one or more electric vehicles, the system comprising:
a robot;
a first electric charger;
a first vehicle localization structure defining a first charge zone located at a first fixed position; and
a central control system configured to:
determine that a corresponding electric vehicle of the one or more electric vehicles is in the first charge zone;
determine a position of a charge port of the corresponding electric vehicle based on the first fixed position of the first vehicle localization structure and vehicle parameters of the electric vehicle; and
instruct the robot to move a charger of the first electric charger from the first electric charger to the charge port of the corresponding electric vehicle such that the charger is electrically coupled to the corresponding electric vehicle.

2. The system of claim 1, wherein the vehicle parameters comprise vehicle dimensions, tire locations and dimensions, and charging port locations and dimensions.

3. The system of claim 1, wherein the first vehicle localization structure includes a pair of rails extending parallel to each other and defining the first charge zone therebetween, and wherein the pair of rails set a lateral position of the corresponding electric vehicle when the corresponding electric vehicle is located in the first charge zone.

4. The system of claim 3, wherein the first vehicle localization structure includes a pair of locking rollers defining the first charge zone therebetween, and wherein the pair of locking rollers set a longitudinal position of the corresponding electric vehicle when the corresponding electric vehicle is located in the first charge zone.

5. The system of claim 1, wherein the first vehicle localization structure includes a pair of locking rollers defining the first charge zone therebetween, and wherein the pair of locking rollers set a longitudinal position of the corresponding electric vehicle when the corresponding electric vehicle is located in the first charge zone.

6. The system of claim 5, wherein the pair of locking rollers are movable between a stowed position in which the pair of locking rollers are disengaged from a wheel of the corresponding electric vehicle when the wheel of the corresponding electric vehicle is located in the first charge zone, and a deployed position in which the pair of locking rollers are engaged with the wheel of the corresponding electric vehicle when the wheel of the corresponding electric vehicle is located in the first charge zone.

7. The system of claim 5, wherein one locking roller of the pair of locking rollers is movable between a stowed position in which the one locking roller is disengaged from a wheel of the corresponding electric vehicle when the wheel of the corresponding electric vehicle is located in the first charge zone, and a deployed position in which the one locking roller is engaged with the wheel of the corresponding electric vehicle when the wheel of the corresponding electric vehicle is located in the first charge zone.

8. The system of claim 7, further comprising a motor operable in a first state in which the one locking roller is in the stowed position and a second state in which the one locking roller is in the deployed position.

9. The system of claim 1, further comprising:
a second electric charger; and
a second vehicle localization structure defining a second charge zone located at a second fixed position.

10. The system of claim 9, further comprising an overhead rail structure, the robot supported by the overhead rail structure and configured to move along the overhead rail structure between the first and second electric chargers.

11. The system of claim 1, wherein the robot is a mobile robot, and wherein the mobile robot is configured to autonomously travel proximate the first charge zone to charge the electric vehicle.

12. The system of claim 1, further comprising a vehicle detection system in communication with the central control system and configured to detect the corresponding electric vehicle in the first charge zone.

13. A system for charging one or more electric vehicles, the system comprising:
a first electric charger;
a rail structure;
a robot supported by the rail structure and configured to move along the rail structure;
a first vehicle localization structure defining a first charge zone located at a first fixed position;
a vehicle detection system configured to detect a corresponding electric vehicle of the one or more electric vehicles in the first charge zone; and
a central control system configured to:
obtain data from the vehicle detection system that the corresponding electric vehicle is in the first charge zone;
determine a position of a charge port of the corresponding electric vehicle based on the first fixed position of the first vehicle localization structure and vehicle parameters of the corresponding electric vehicle; and
instruct the robot to move a charger of the first electric charger from the first electric charger to the charge port of the corresponding electric vehicle such that the charger is electrically coupled to the corresponding electric vehicle.

14. The system of claim 13, wherein the vehicle parameters comprise vehicle dimensions, tire locations and dimensions, and charging port locations and dimensions.

15. The system of claim 13, wherein the first vehicle localization structure includes a pair of rails extending parallel to each other and defining the first charge zone therebetween, and wherein the pair of rails set a lateral position of the corresponding electric vehicle when the corresponding electric vehicle is located in the first charge zone.

16. The system of claim 13, wherein the first vehicle localization structure includes a pair of locking rollers defining the first charge zone therebetween, and wherein the pair of locking rollers set a longitudinal position of the corresponding electric vehicle when the corresponding electric vehicle is located in the first charge zone.

17. The system of claim 16, wherein the pair of locking rollers are movable between a stowed position in which the pair of locking rollers are disengaged from a wheel of the corresponding electric vehicle when the wheel of the corresponding electric vehicle is located in the first charge zone, and a deployed position in which the pair of locking rollers are engaged with the wheel of the corresponding electric vehicle when the wheel of the corresponding electric vehicle is located in the first charge zone.

18. The system of claim 17, wherein the central control system moves the pair of locking rollers from the stowed position to the deployed position in response to the central control system obtaining data from the vehicle detection system that the corresponding electric vehicle is in the first charge zone.

19. The system of claim 13, further comprising:
a second electric charger; and
a second vehicle localization structure defining a second charge zone located at a second fixed position,
wherein the robot is configured to move along the rail structure between the first and second electric chargers.

20. A method for charging one or more electric vehicles, the method comprising:
obtain data from a vehicle detection system that a corresponding electric vehicle of the one or more electric vehicles is in a charge zone of a vehicle localization structure;
determine a position of a charge port of the corresponding electric vehicle based on a fixed position of the vehicle localization structure and vehicle parameters of the corresponding electric vehicle; and
control a robot to move a charger of an electric charger from the electric charger to the charge port of the corresponding electric vehicle such that the charger is electrically coupled to the corresponding electric vehicle.
